(19) United States
(12) Patent Application Publication
(10) Pub. No.: US 2014/0285353 A1
(43) Pub. Date: Sep. 25, 2014

(54) INDICATING CIRCUIT AND ELECTRONIC DEVICE USING THE SAME

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: HAI-DONG TANG, Shenzhen (CN)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/062,607

(22) Filed: Oct. 24, 2013

(30) Foreign Application Priority Data
Mar. 22, 2013 (CN) 2013100938065

(51) Int. Cl. G08B 5/36

(52) U.S. Cl. CPC G08B 5/36
USPC 340/691.8

(57) ABSTRACT

An electronic device connected to a power supply comprises a load, an protection module, and an indicating circuit. The protection module is connected between the power supply and the load, and is capable of establishing a connection between the power supply and the load or cutting off the connection. The indicating circuit connected to the power supply and the protection module is capable of outputting different indicating information based on different states of the protection module. When the protection module establishes the connection between the power supply and the load, the indicating circuit outputs first indicating information. When the protection module cuts off the connection between the power supply and the load, the indicating circuit outputs second indicating information.

### BACKGROUND

1. Technical Field

The present disclosure relates to an electronic device with an indicating circuit.

2. Description of Related Art

Electronic devices include a power supply, a load, and a fuse connected between the power supply and the load. When a current is in an over current state, the fuse is melted disabling the electronic device and preventing the load from being destroyed. However, there are different reasons that cause the electronic device to become disabled, a multimeter is needed for manually determining whether the fuse is melted, therefore the operations are complicated.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an electronic device in accordance with one embodiment.

FIG. 2 is a circuit diagram of the electronic device of FIG. 1 in accordance with one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at “least one.”

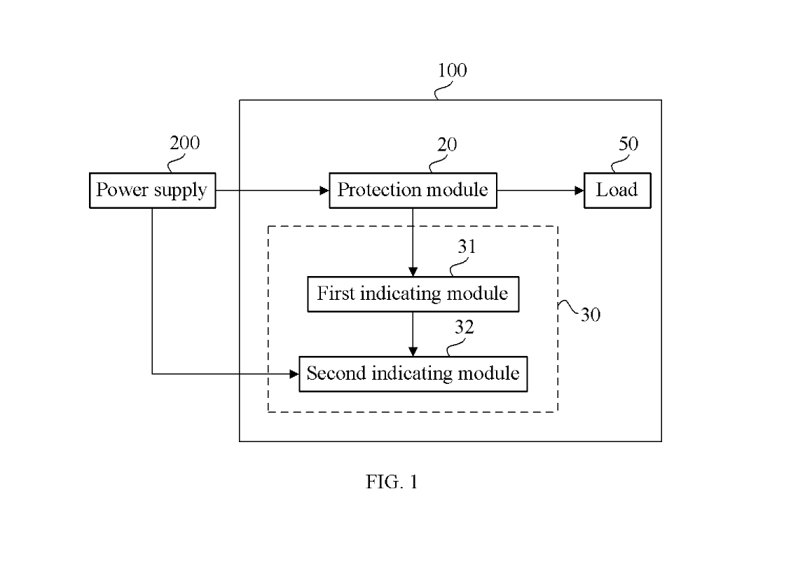

FIG. 1 shows an electronic device 100 of one embodiment of the present disclosure. The electronic device 100 with a fuse connected to a power supply 200 outputs different indication information for indicating the fuse's different states.

The electronic device 100 includes a protection module 20, an indicating circuit 30, and a load 50.

The protection module 20 is connected between the power supply 200 and the load 50. The protection module 20 establishes a connection between the power supply 200 and the load 50 when the current passing through the protection module 20 is less than a predetermined value, further generates a first control signal to the indicating circuit 30. The protection module 20 cuts off the connection between the power supply 200 and the load 50 when the current passing through the protection module 20 is more than the predetermined value, and further generates a second control signal to the indicating circuit 30.

The indicating circuit 30 is connected to the power supply 200 and the protection module 20. The indicating circuit 30 outputs first indicating information in response to the first control signal, and outputs second indicating information in response to the second control signal. The indicating circuit 30 includes a first indicating module 31 and a second indicating module 32.

The first indicating module 31 is connected between the protection module 20 and the second indicating module 32. The first indicating module 31 outputs first indicating information and controls the second indicating module 32 to be disabled for outputting second indicating information when the first control signal from the protection module 20 is received, and is disabled for outputting the first indicating information when the second control signal from the protection module 20 is received. In the embodiment, the first indicating information is a green light, and the second indicating information is a red light.

The second indicating module 30 is connected to the power supply 200 and the first indicating module 31. The second indicating module 32 outputs the second indicating information when the first indicating module 31 is disabled.

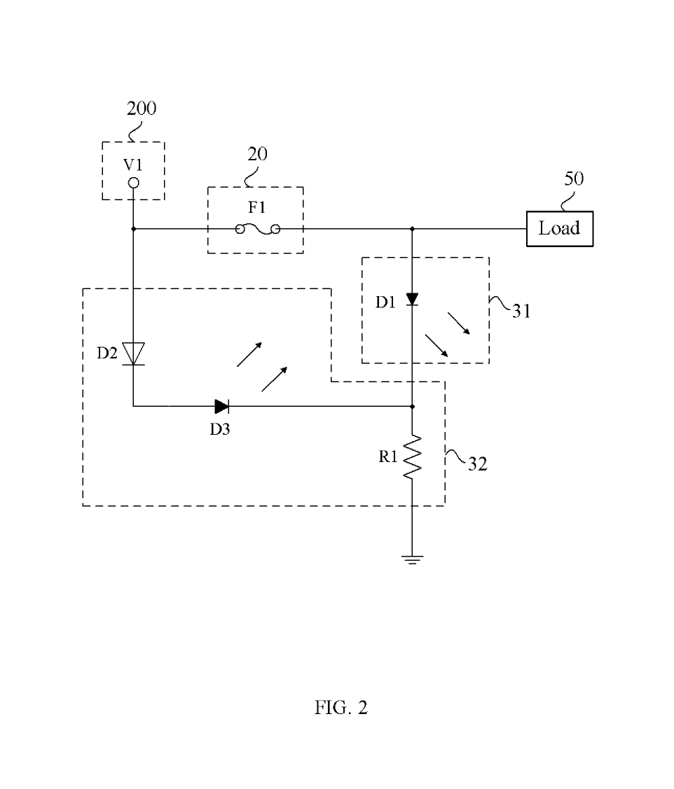

FIG. 2 shows that the power supply 200 includes a power source V1.

The protection unit 20 includes a fuse F1. Opposite terminals of the fuse F1 are connected to the power source V1 and the load 50.

The first indicating module 31 includes a first light-emitting diode D1. An anode of the first light-emitting diode D1 is connected between the fuse F1 and the load 50. A cathode of the first light-emitting diode D1 is grounded through the resistor R1.

The second indicating module 32 includes a second light-emitting diode D2, a diode D3, and a resistor R1. An anode of the second light-emitting diode D1 is connected to the power source V1 through the diode D3. A cathode of the second light-emitting diode D2 is connected between the cathode of the first light-emitting diode D1 and the resistor R1. An anode of the diode D3 is connected to the power source V1. A cathode of the diode D3 is connected to the anode of the second light-emitting diode D2.

The principle of the electronic device 100 is described, when the current passing through the fuse F1 is less than the predetermined value, the power terminal V1 outputs the working voltage to the load 50. The voltage difference between the anode and the cathode of the first light-emitting diode D1 is more than 0.7 volt (V), the first light-emitting diode D1 turns on and emits light in a first color. Because of the diode D3 and the resistor R1, the voltage difference between the anode and the cathode of the second light-emitting diode D2 is less than 0.7V, the second light-emitting diode D2 turns off and does not emit light in a second color.

When the current passing through the fuse F1 is more than the predetermined value, the fuse F1 is blown and cuts off the connection between the power terminal V1 and the load 50. The voltage difference between the anode and the cathode of the first light-emitting diode D1 is less than 0.7V, the first light-emitting diode D1 turns off and stops emitting light in the first color. The voltage difference between the anode and the cathode of the second light-emitting diode D2 is more than 0.7V, the second light-emitting diode D2 turns on and emits light in the second color. As a result, the different states of the fuse F1 are indicated by the different indicating information of the indicating circuit 20.

It is to be understood, however, that even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An indicating circuit connected to a protection module connected between a power supply and a load; the protection module capable of establishing a connection between the power supply and the load or cutting off the connection; the indicating circuit for indicating current state of the protection module comprising:
a first indicating module connected to the protection module, and capable of outputting first indicating information; and
a second indicating module connected to the power supply and the first indicating module, and capable of outputting second indicating information;
wherein when the protection module establishes the connection between the power supply and the load, the first indicating module outputs the first indicating information and controls the second indicating module to be disabled for outputting the second indicating information; when the protection module cuts off the connection between the power supply and the load, the first indicating module stops outputting the first indicating information, and the second indicating module outputs the second indicating information when the disable signal is not received.

2. The indicating circuit of claim 1, wherein the first indicating module comprises a first light-emitting diode; an anode of the first light-emitting diode is connected between the protection module and the load; a cathode of the first light-emitting diode is connected to the second indicating module.

3. The indicating circuit of claim 1, wherein the second indicating module comprises a second light-emitting diode, a diode, and a resistor; an anode of the second light-emitting diode connected to the power supply through the diode; a cathode of the second light-emitting diode is grounded through the resistor; an anode of the diode is connected to the power supply; a cathode of the diode is connected to the anode of the second light-emitting diode.

4. The indicating circuit of claim 1, wherein the first indicating information is a green light; and the second indicating information is a red light.

5. An electronic device connected to a power supply, comprising:
a load;
an protection module connected between the power supply and the load, and capable of establishing a connection between the power supply and the load or cutting off the connection; and
an indicating circuit connected to the power supply and the protection module, and capable of outputting different indicating information based on different states of the protection module;
wherein when the protection module establishes the connection between the power supply and the load, the indicating circuit outputs first indicating information; when the protection module cuts off the connection between the power supply and the load, the indicating circuit outputs second indicating information.

6. The electronic device of claim 5, wherein the electronic device comprises a first indicating module and a second indicating module; the first indicating module is connected between the protection module and the second indicating module; the second indicating module is connected to the power supply; when the protection module establishes the connection between the power supply and the load, the first indicating outputs the first indicating information and controls the second indicating module to be disabled for outputting the second indicating information; when the protection module cuts off the connection between the power supply and the load, the first indicating module stops outputting the first indicating information, and the second indicating module outputs the second indicating information.

7. The electronic device of claim 6, wherein the first indicating module comprises a first light-emitting diode; an anode of the first light-emitting diode is connected between the protection module and the load; a cathode of the first light-emitting diode is connected to the second indicating module.

8. The electronic device of claim 6, wherein the second indicating module comprises a second light-emitting diode, a first diode, and a resistor; an anode of the second light-emitting diode connected to the power supply through the first diode; a cathode of the second light-emitting diode is grounded through the resistor; an anode of the first diode is connected to the power supply; a cathode of the first diode is connected to the anode of the second light-emitting diode.

9. The electronic device of claim 5, wherein the protection module comprises a fuse; when a current passing through the protection module is more than a predetermined value, the protection module cuts off the connection between the power supply and the load.

10. The electronic device of claim 5, wherein the first indicating information is a green light; and the second indicating information is a red light.
